(19) United States
(12) Patent Application Publication
(10) Pub. No.: US 2009/0006113 A1
(43) Pub. Date: Jan. 1, 2009

(54) Method for Structuring and Controlling an Organization

(76) Inventors: Brian Robertson, Spring City, PA (US); Anthony Moquin, Glenmoore, PA (US); Gareth Powell, Exton, PA (US)

Correspondence Address: Bressler, Amery & Ross, P.C., 17 State Street, New York, NY, 10004, US

(21) Appl. No.: 11/771,691

(22) Filed: Jun. 29, 2007

(51) Int. Cl. G06Q 10/00; G06F 9/46

(52) U.S. Cl. 705/1; 705/9

(57) ABSTRACT

The instant application provides a method for running an organization. Each individual in the organization is assigned to one of a plurality of circles. The circles uses dynamic steering in the performance of periodic governance meetings. The governance meetings are used to: define accountabilities, in which each accountability is an activity performed in service of the organization; define roles; assign to each role at least one of the accountabilities; assign to each individual in the circle at least one of the roles, wherein each individual filling a role is accountable to the organization for every accountability assigned to that role; and using a decision-making process to resolve identified tensions within the circle. Additionally, the circles use dynamic steering in the performance of periodic operational meetings. The operational meetings are used to: exchange information and make decisions requiring integration of multiple roles in the circle; review metrics relevant to the circle; and resolve tactical issues related to the circle.

### FIELD OF THE INVENTION

The present invention relates generally to methods for structuring and controlling an organization. More particularly, the present invention discloses an integrative approach that employs self-organizing teams and dynamic steering to provide rapid feedback and response cycles for governing and running a business.

### BACKGROUND OF THE INVENTION

Whenever two or more people work together towards a common goal, they will organize to do so, and at this point an organization exists. In any organization control questions arise, such as: Who will make which decisions? Who will tell whom to do what? Who will handle what work, and what processes will be followed to do the work? When and how will deviations from the established process be handled, and who will make that decision? How will internal questions, such as these, be answered, and how and when will answers be updated as the situation changes? These are fundamental questions that must be addressed by any organization, particularly businesses.

Various types of governing structures have been offered and tried in answer to these questions. In the typical modern corporation, a limited democracy is provided external to the day-to-day operations of the corporation. Shareholders elect board members by voting their shares, and the board in turn appoints a CEO by majority vote. From there, however, all makings of decisions and expectations is autocratic, with the CEO having near supreme power. Typically, the CEO delegates some of his power to managers, creating what is akin to a feudal hierarchy. This hierarchy steers the organization through top-down, predict-and-control planning and management. Those lower in the hierarchy have virtually no voice except by the good graces of those above, and no official way to ensure key insights or information they hold are incorporated into plans or policies. Even at its best, this organizational structure tends to be inflexible to change and ill-equipped to artfully navigate the complex landscape most businesses face today.

Some companies attempt to skip an explicit power structure, or use only a minimally defined one. Such organizational structures may work to a point, but typically with no explicit power structure in place one will implicitly emerge over time. Decisions need to be made and they will be made, one way or another; social norms develop as a result. At best a healthy autocratic structure of some sort may emerge, though more often than not organizations using this approach end up with something far more insidiously dominating and ineffective.

Other corporations attempt to include an organization-via-consensus approach. These structures, however, don't scale at all, and the time and energy required is often so impractical that the system is bypassed for most decisions. The net result tends to leave the corporation with no explicit structure, with all the attendant problems thereto, and sometimes with even worse problems in addition, as consensus can pull people towards an egocentric space. Similarly, structures that attempt to incorporate internal democracies often result in the same challenges and inflexibility as autocracies but with a higher time-cost. To make matters worse, the majority rarely knows best, with the end result of ineffective decisions being made in addition to all the other downsides of autocracies.

Hence, while these approaches may have some merit, none are highly effective at harnessing true self-organization and agility throughout the enterprise. Accordingly, there is an immediate need for an improved method for structuring and controlling an organization.

### SUMMARY OF THE INVENTION

Various embodiments provide a method for running an organization. In certain embodiments the organization is an entire company; in other embodiments, the organization is a sub-set or portion of a company, or a group of individuals working together towards a common aim but not in the context of a legal entity. This method includes assigning each individual in the organization to at least one of a plurality of circles. At least one of the circles uses dynamic steering in the performance of periodic governance meetings. The governance meetings are used to: define accountabilities, in which each accountability is an activity performed in service of the organization; define a plurality of roles; assign to each role at least one of the accountabilities; assign to each individual in the circle at least one of the roles, wherein each individual filling a role is accountable to the organization for every accountability assigned to that role; and using a decision-making process to resolve identified tensions within the circle. Additionally, at least one circle uses dynamic steering in the performance of periodic operational meetings. The operational meetings are used to: exchange information and make decisions requiring integration of multiple roles in the circle; review metrics relevant to the circle; and resolve tactical issues related to the circle. In certain embodiments, all of the circles in the organization employ governance meetings and operational meetings. In preferred embodiments, the decision-making process to resolve identified tensions within the circle employs a Decisions by Integrative Emergence process.

In various embodiments, the method further comprises each individual in the organization utilizing individual action. Individual action comprises utilizing the best judgment of the individual to identify a task to be performed that is not already accounted for by a current accountability, or which is contrary to a current accountability; performing the task; and raising in a subsequent governance meeting the task. In certain preferred embodiments, individual action further comprises performing any reasonable restorative action in response to performing the task.

In certain preferred embodiments, each of the circles has a lead link role with a related accountability of aligning the circle with requirements established by another circle, and a representative link role with a related accountability of ensuring another circle provides a conducive environment for the circle. The individuals filling the lead link and representative link roles typically attend the governance meetings of both circles, and may attend the operational meetings of both circles.

In some embodiments the circles are semi-autonomous, self-organizing structures. As such, the governance meetings for a circle may include the following additional tasks: partitioning the circle into a plurality of sub-circles; and assigning to each sub-circle a member of the circle to serve as a lead link for that sub-circle. The sub-circles may each perform an election process to elect a representative link for that sub-circle who will serve as a member in the governance meetings of the circle.

In other embodiments, roles are semi-autonomous elements with autocratic executive power to perform the accountabilities assigned to that role. As such, a role may have the authority to: partition the role into a plurality of sub-roles; for at least one of the sub-roles, assigning at least one of the accountabilities corresponding to the role to that sub-role; and assigning an individual to fill each sub-role.

In preferred embodiments, circles have full executive authority to change roles and their related accountabilities. Hence, in various embodiments, the governance meetings perform the following additional task: identifying a first role with corresponding accountabilities; partitioning the first role into a plurality of second roles; for at least one of the second roles, assigning at least one of the accountabilities corresponding to the first role to that second role; and assigning an individual to fill each second role.

In another aspect, a decision-making method for an organization is provided that adapts clearly-defined roles and accountabilities in response to new information. The decision-making method includes: identifying at least one accountability that is an activity to be performed for the organization; assigning the accountability to a first role; assigning an individual to fill the first role; providing the individual autocratic power to reasonably execute all accountabilities assigned to the first role; identifying a tension within the organization; and adding an accountability to, or modifying an existing accountability associated with, the first role to resolve the tension.

In various embodiments, the first role is an element of a circle comprising a plurality of roles. The circle employs a governance meeting to add an accountability to, or modify an existing accountability associated with, the first role to resolve the tension identified to the circle. In preferred embodiments, the governance meeting utilizes a Decisions by Integrative Emergence process to adjust the roles and accountabilities.

In another aspect, a further decision-making process for an organization is provided. In these embodiments, a tension is presented to a group within the organization. Information about the tension is solicited from the group. A proposed decision to resolve the tension is then requested from members of the group. Objections to the proposed decision are also solicited from the group. However, an objection, to be valid, is an objectively reasonable explanation for why the proposed decision is outside a limit of tolerance of the organization. In preferred embodiments, the objection must further be limited to reasons presently and factually known to be before the organization, and may not include potential future events or possibilities. These steps are repeated while any objection is present. Finally, a proposed decision that has no outstanding objections is accepted as the course of action for the organization. In preferred embodiments, the first proposed decision without an objection is accepted as the course of action for the organization.

### BRIEF DESCRIPTION OF THE DRAWINGS

FIG. 1 shows an embodiment circle structure for a hypothetical corporation.

FIG. 2 is a traditional organizational chart for the corporation shown in FIG. 1.

FIG. 3 overlays the circle structure of FIG. 1 on top of the traditional organizational chart of FIG. 2.

FIG. 4 illustrates internal and external feedback within and between circles as provided by an embodiment organizational structure.

FIG. 5 shows the addition of embodiment representative links on the organizational chart depicted in FIG. 3.

FIG. 6 is a flow chart of an embodiment Decisions by Integrative Emergence process.

FIG. 7 is a flow chart of an embodiment Decisions by Integrative Emergence process.

FIG. 8 is a flow chart of an embodiment governance process.

FIG. 9 is a flow chart of an embodiment integrative election process.

FIG. 10 is a flow chart of an embodiment tactical process.

### DETAILED DESCRIPTION

A brief overview of various aspects of embodiment methods is initially provided. Subsequently, these aspects, and others, will be covered in greater detail, as will the interrelationships of these various aspects. In addition, attention may be drawn to the following articles, the contents of which are incorporated herein by reference: Brian J. Robertson, “Holacracy: A Complete System for Agile Organizational Governance and Steering,” Agile Project Management, Vol. 7, No. 7; Dr. Gareth Powell, “Mapping Our Decision Making,” Integral Leadership Review, Vol. 7, No. 3; Brian J. Robertson, “An Interview with Brian Robertson: President of Ternary Software, Inc. on Holacracy™”, available at http://www.ternarysoftware.com/pages/downloads/BrianRobertsonInterview2006-02-08v3.pdf; Sociocracy In Action, “Interview with Brian Robertson Transcript: Shared Learnings on Sociocracy and Holacracy™”, available at http://ternarysoftware.com/pages/downloads/HolacracyInterviewTranscript-2006-06-13.pdf.

### Organizational Structure

Various embodiments seek to align the explicit structure of an organization with its more organic natural form, replacing artificial hierarchy with a fractal-like relationship of self-organizing teams, which may be termed “circles.” Conceptually, in certain embodiments these circles may be arranged as nested sets. Each circle may connect to each of its sub-circles via a double-link, where a member of each circle is appointed to sit on the other, creating a bidirectional flow of information and rapid feedback loops. Each circle may govern itself by uncovering roles needed to reach the goal of the circle, and assigning circle members to fill these roles.

### Organizational Control

Various embodiments provide for methods that lead to decisions that are made rapidly and incrementally with maximal information. The embodiment decision-making methods provide for control that adapts continuously as new information emerges. In other embodiments, when decisions and actions to be taken are unclear, the embodiment decision-making methods encourage individual action using a best-judgment approach, the acceptance of ownership of the impact resultant from the decision, and organizational assimilation of these impacts to learn from the experience.

### Core Practices

Various embodiments provide core practices that include periodic circle meetings for both governance and operations. Governance meetings may be used to define how circles, and the individuals which compose them, will work together; they facilitate uncovering and assigning of roles needed to reach the goal of a circle. Operational meetings may be used to get work done; they facilitate effective planning and execution of the day-to-day business of a circle. Although “periodic” may mean “at regularly-spaced intervals,” it also intended to include irregularly spaced intervals.

### I. Organizational Structure

A. Roles & Accountabilities

A typical organizational question in any business is: To whom is an employee accountable? Dissection of this question leads to several other corollary questions: Who actually counts on the employee? Certainly, for example, the immediate manager counts on the employee. Yet, it is also clear that close coworkers of the employee may also rely on the employee. If the employee holds a managerial position, then those working under the employee also rely on that employee. Individuals in separate parts of the organization may also rely on the employee from time to time for certain tasks. Indeed, customers of the business may explicitly rely upon the employee for certain things. An employee may thus be “accountable” to any number of people both in and out of the organization.

Rather than attempting to define to whom an employee is accountable, a much more useful question is: For what is the employee accountable? A lack of mutual understanding around the answer to this fundamental question can lead to interpersonal strife. When members of an organization have different expectations of what they are counting on each other for, important needs may be dropped and frustration may ensue amongst all members. If there is no clear and compelling mechanism to sort out this misalignment of expectations directly with each other, then playing politics becomes an effective path to working around the system, and this can lead to interpersonal drama and wasted energy. Worse yet, members rarely consciously recognize that they have a misalignment of expectations; instead, they may make up stories about each other, or blame each other, and the spiral continues.

On the other hand, when the members of an organization, such as a business, have an effective process and supporting culture to clarify what they will count on each other for, they can channel the frustration of misaligned expectations into an opportunity for organizational learning and evolution. Politics is no longer a useful tool, and the personal drama gives way to an explicit discussion of what makes sense to count on each other for.

1. From Accountabilities to Roles

In various embodiments, an “accountability” is one specifically defined activity or task that the organization is counting on. An accountability typically, but not necessarily, begins with an “-ing” verb, such as “facilitating a daily meeting,” or “faxing documents upon request,” or “managing overall resource allocation for the company.” Whenever an accountability is defined, it is also immediately attached to a “role.”

Roles hold multiple related accountabilities in a cohesive container. The list of explicit accountabilities is detailed and granular, thereby avoiding “title trap.” Title trap arises from the common belief that expectations are made explicit just by creating a job title or a place in the management hierarchy. More often than not these approaches just add to the politics and personal drama, because now members of an organization think they have clarified the organizational structure, but in reality they have simply created more opportunity for unconsciously assumed, misaligned expectations. In various embodiments of the instant method, the title of a role becomes secondary, and is merely a label. The real descriptor of the role becomes the list of explicit accountabilities. Each role is provided all executive power needed to fulfill the related accountabilities, within optional limits that may also be defined. In various embodiment, limits on executive power may be cast as additional accountabilities. For example, a limit on spending power may be cast as an accountability to “gain approval from Finance before spending money,” or “soliciting and integrating input from all Circle Members before committing to making a large investment.”

By way of example, in a software company, the role of “Project Manager” may have the following list of accountabilities that define that role: creating and maintaining a project release plan; facilitating the creation of contracts; invoicing clients at the end of each month; sending a daily status email to the project team; holding a retrospective after each phase of a project; and publishing project metrics at operational meetings. The term “Project Manager” is thus simply a shorthand way of addressing a role that must account for the listed activities, and a “Project Manager” is provided whatever limited executive power is needed to accomplish and fulfill these accountabilities. As will be explained in more detail later, in certain embodiments the individual filling a role isn't actually required to do everything identified as an accountability. Rather, the individual is simply required to “account” for the role and to make reasonable decisions.

2. Establishing Accountabilities and Roles

With the detailed accountabilities used in various embodiment methods, any given role may have dozens of accountabilities, and any given individual may fill multiple roles. Attempting to define what all of these accountabilities and related roles should be up-front can simply lead to guessing, with the attendant danger of grinding progress to a halt and coming up with lists that are soon out-of-date or just plain wrong from the start. To avoid such problems, various embodiments seek to clarify accountabilities over time, as tensions actually arise from unclear implicit accountabilities or conflicts between roles. In certain preferred embodiments, however, theses accountabilities are created only in response to a clear need, as determined by a related tension, for doing so; when there are no tensions arising from the lack of an explicit accountability, then there is no need to create such an explicit accountability. This follows from another aspect of the various embodiments, termed Dynamic Steering, which is covered later. A “tension” may be defined as a feeling that something could be better than it presently is. That is, a tension may be a gut feeling an employee gets seeing something that could be improved and wants to see improved. This may arise, for example, because of something that is not going well right now, or because the employee has a vision of a better way of doing something.

3. Filling Roles

Whenever a new role is defined, it is then assigned to a member of the organization to fill and execute. This formally gives that member control to do what is reasonably needed to enact the accountabilities of the role, within any defined limits; in preferred embodiments, accountability always goes with control. In certain embodiments, limits on control may be left to the reasonable determination of the individual, thus permitting individuals to figure out what control they need to exert to meet their respective accountabilities, within the bounds defined by any other explicit accountabilities (e.g. an accountability to get approval from someone). Rather than leading to systemic abuses, such freedom tends to render a more finely defined system of roles and accountabilities; for when someone ends up taking more control than is healthy for the system, tensions arise and get integrated through the governance process, discussed later, and turned into new accountabilities to appropriately limit the control or otherwise address the tension. Assignment of a role to an individual also gives others in the organization the reasonable expectation that they can ask the individual to account for any of the explicit accountabilities associated with that role. Additionally, by clearly defining roles with associated accountabilities, the various embodiment methods provide for a clear differentiating between the role and the individual fulfilling that role. Personal politicking as a tool for organizational governance is substantially, if not entirely, eliminated, as such politicking typically requires structural ambiguity in roles, and this is simply eliminated by defining a role by concrete, discrete accountabilities that are publicly known.

Of particular note is that one way an individual may “account” for an accountability is by consciously deciding not to perform that task in favor of another that the individual believes, for example, to be of greater importance. Such a deliberate choice to not perform the task required by an accountability is, in various embodiments, considered to be a fulfilling of that accountability; though it may also indicate that something else is needed. Consciously deciding to not execute an accountability is often quite normal and perfectly healthy. In the event, however, that it is not to the overall benefit of the organization, it should be noted that someone else is in the organization is accountable for ensuring that the individual assigned to the related role is a good fit for their role, and that along with the accountability for personnel assignments comes the attendant control to change that assignment.

For example, assume a role R₁ with an associated accountability A₁ is assigned to person X. Further assume that X persistently fails to perform A₁, and hence, by implication, is failing to fulfill role R₁. A person Y fulfilling a role R₂, which includes the accountability A₂ of assigning people to fulfill role R₁, will, either directly or via the core practices that are discussed later, quickly learn of the failure of X to fulfill role R₁. By way of core practices, Y will also learn why X is unable or unwilling to perform A₁. Y, to fulfill role R₂, will then have the accountability to see that either role R₁ is changed so that accountability A₁ is reassigned or otherwise accounted for, or that role R₁ is assigned to someone other than X who can actually fulfill the role in its entirety.

B. Circle Organization

A “circle” in various embodiments is a self-organizing team. Each circle has a goal or purpose, and the authority to define and assign its own roles and accountabilities. Each circle has a breadth of scope it focuses on. For example, some circles may be focused on implementing specific projects, others on managing a department, and others on overall business operations. Regardless of the level of scale of a circle, the same basic rules apply. As will be touched upon in greater detail, each circle is composed of its “home” members, which are those naturally encompassed by the bounds of the circle, and linking members that may be from other circles.

Each circle may be considered a holon, which is a whole, self-organizing entity in its own right, and typically is part of a larger circle. That is, the organizational structure may be thought of as composed of a nested hierarchy of circles of increasing wholeness, where each broader circle transcends and includes its sub-circles, while also adding something novel as a whole and so generally cannot be explained as merely the sum of its parts. For example, a whole project team circle may also be a part of a department circle. Like all holons, each circle expresses its own cohesive identity—it has autonomy and self-organizes to pursue its goal. Regardless of the specific area or level of scale a circle is focused on, it makes its own policies and decisions to govern that level of scale (which may be termed “leading”), it does or produces something (which may be termed “doing”), and it collects feedback from the doing (which may be termed “measuring”) to guide adjustments to its policies and decisions (“leading”), which creates a self-organizing feedback loop.

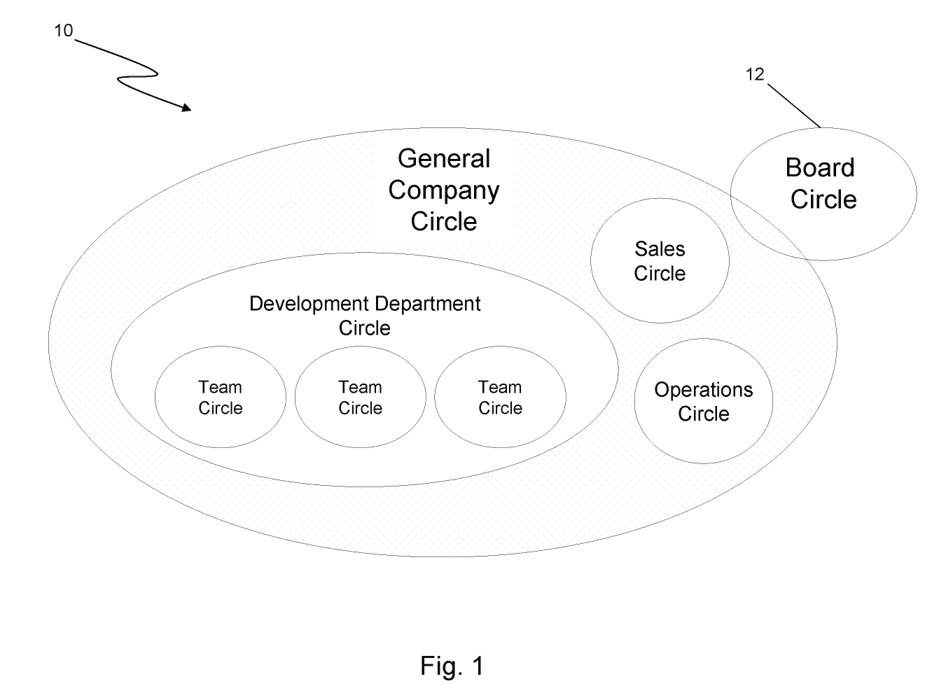

FIG. 1 shows a view of an example embodiment circle structure 10 for a software development organization. Each broader circle transcends and includes its sub-circles, except for the Board 12, which is a bit of a special case discussed later.

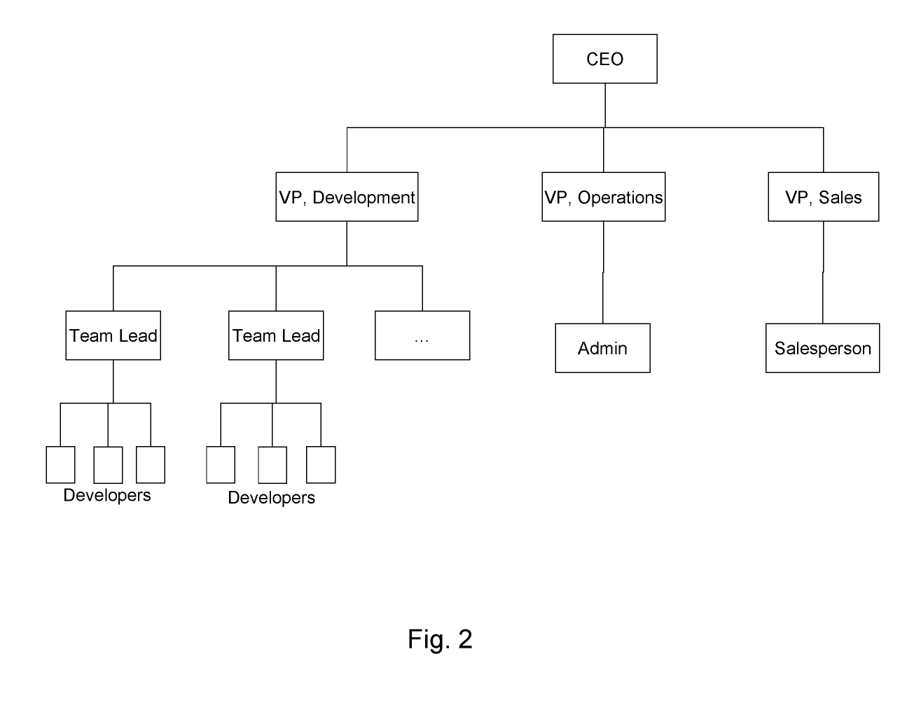

A traditional organizational chart for the same company is shown in FIG. 2. The embodiment organizational method does not necessarily make obsolete this traditional organizational chart, although the traditional view is now incomplete, and has a subtly different meaning within cultural context of the embodiment methods.

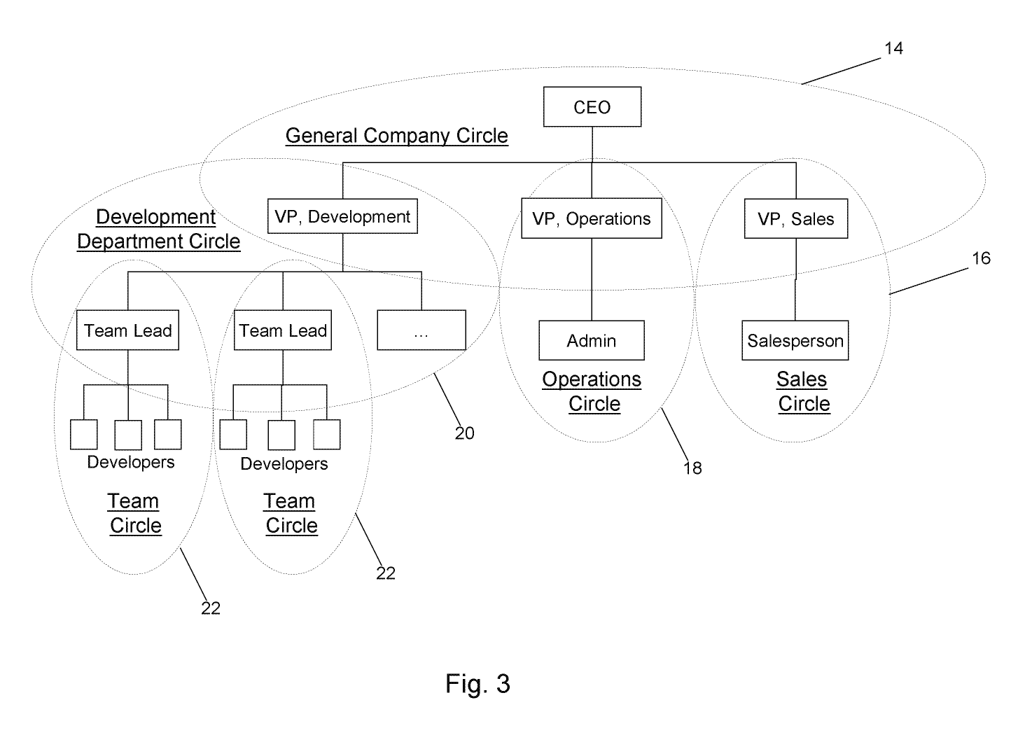

FIG. 3 brings these two views of the organization together by overlaying the circle structure on top of the traditional organizational chart. This is really the same view as FIG. 1, just taken from a different perspective. This view also shows how a manager serves as a connection or conduit between a broader circle and a more focused circle (note how a circle and related sub-circle overlap at the managerial roles).

Although the processes within and between each self-organizing circle will be different from that of a traditional organization, the overall organizational structure is not all that surprising. At the broadest level, the Board of Directors and the CEO form a Board Circle 12, integrating the concerns of the outside world into the organization. Below that, the CEO and the department heads (the executive team) form a General Company Circle 14, with scope over all cross-cutting operational functions and domains, except those specific functional areas which are delegated to department sub-circles (Sales Circle 16, Operations Circle 18, and Development Department Circle 20). One of the departments is large enough to go one step further and break itself down into various Project Team Circles 22, each owning a different set of client engagements. Of course this is just one example for one company; any given organization will look different, and even the same organization may evolve dramatically over time, as will be touched upon later.

1. Double Linking

Decisions and operations of one circle are not fully independent of others. Each whole circle is also a part of a broader circle, and shares its environment with the other functions and sub-circles of that broader circle. So, a circle can not be fully autonomous; the needs of other circles must be taken into account in its self-organizing process. To achieve this, a sub-circle and its super-circle may be linked together, for example, by two or more roles (and thus two or more individuals respectively filling those roles). Each of these two link roles takes part in the governance and operational processes of both connected circles.

One of these two links is appointed from the super-circle to connect to a sub-circle. This may be termed a “Lead Link” role, and may be thought of as akin to a traditional manager (although there are differences, functionally and culturally). A lead link is accountable for aligning the sub-circle's results with the super-circle's needs.

The other half of the double link may be appointed by a sub-circle to connect to its super-circle. This may be termed a “Representative Link” role, or “Rep Link” for short. Like the lead link, the rep link forms part of the membrane between two circles. The role itself is quite different from anything in a modern organization, although it bears some similarity to a lead link (but in the opposite direction). A rep link is accountable for ensuring the super-circle is a conducive environment for the sub-circle, by carrying key perspectives from the sub-circle to the super-circle's governance and operations. A rep link may also be accountable for taking part in the decision-making process of the immediate super-circle, and ensuring that requisite control is maintained within the scope of the sub-circle.

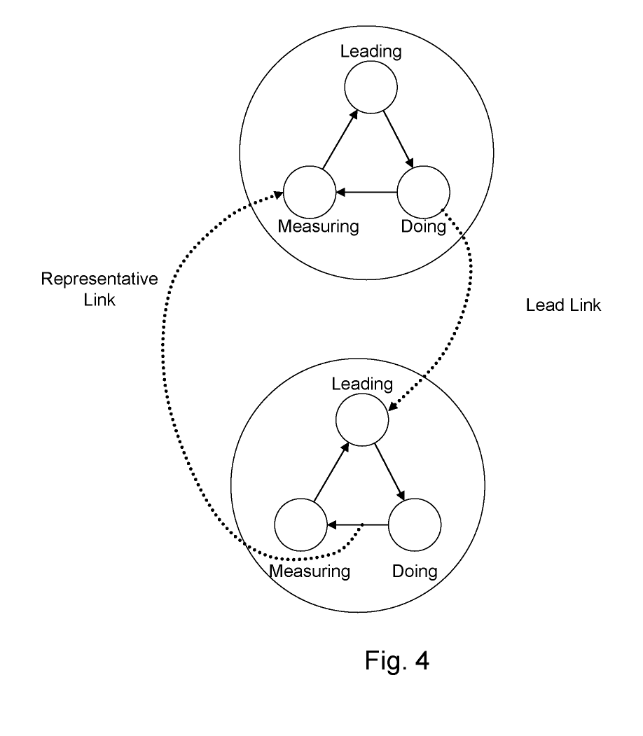

Earlier, it was discussed how each circle may have an internal self-organizing feedback loop of leading, doing and measuring. Double linking plays a role in this internal feedback by providing rapid, bidirectional communications between a sub-circle and its super-circle, which is shown in FIG. 4. Each circle performs its own leading, doing, and measuring—a complete feedback loop for self-steering, which is discussed in more detail later. Yet, to ensure the integrity of the system as a whole, these circles need to connect to the steering processes in the circles respectively above and below themselves (or, equally accurate, in the broader circle around themselves and those circles within themselves). More specifically, when what one circle decides to do (e.g., “build this application”) is going to be performed by a lower-level circle (for instance, a development team), then the higher-level circle's doing links to the leading process for the lower level circle, to carry the needs and relevant information downward. Likewise, the lower-level circle's doing and measuring may feed back into the higher-level circle's measuring process, so that the higher circle can adapt based upon an understanding of the reality and needs of the lower-level circle. Linking between sub- and super-circles thus provides a balance between complete autonomy, which would otherwise permit a sub-circle to go its own way to the detriment of the super-circle, and dominance, which would otherwise permit the super-circle to control the direction of the sub-circle to the detriment and against the better knowledge of the sub-circle—which is the norm in most modern businesses. As shown in FIG. 4, these connections are the roles of the two links; the lead link carries the “doing” of the higher level to the “leading” of the lower level, and the Representative Link carries the “doing” and “measuring” of the lower level to the “measuring” of the higher level. With these links operating as conduits between levels of scale, this embodiment structure ensures that every circle in the organization can act fully as a holon—as both a whole in its own right and as a part of a broader whole. The result is a fractal pattern that can provide healthy autonomy while ensuring healthy communion at every level of scale, with information flowing constantly up and down through feedback loops both within and across circle boundaries.

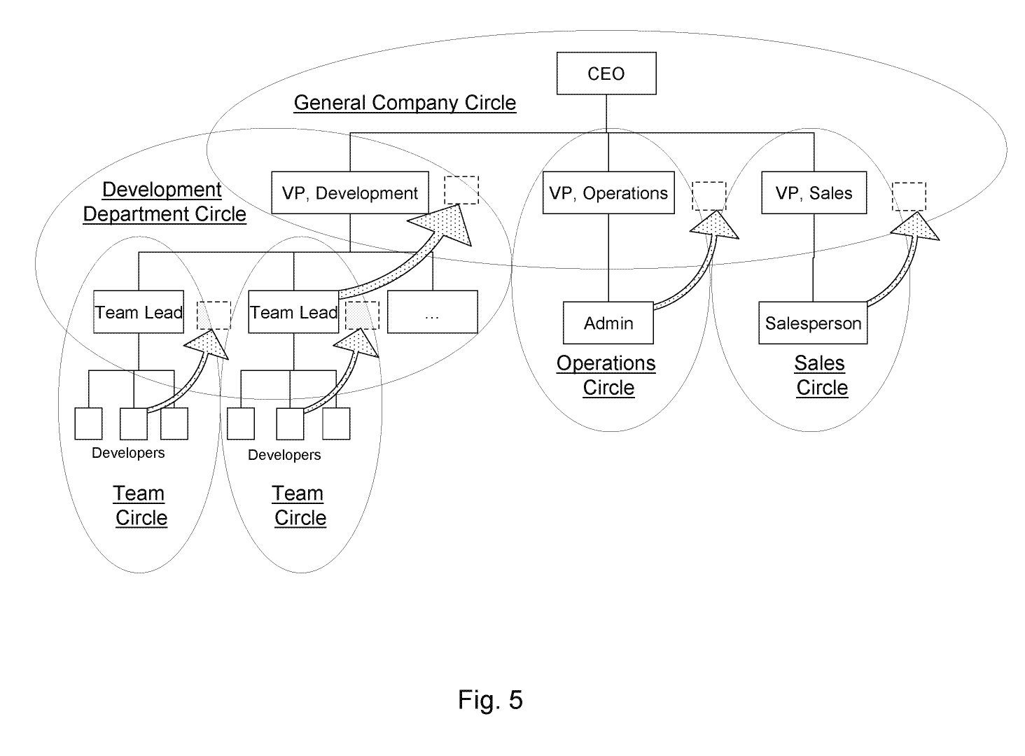

This double linking may continue throughout the entire nested circle structure of the organization. Continuing the example from FIGS. 1 to 3 above, FIG. 5 shows the addition of rep links on the organizational chart, indicated by large arrows. Each circle has appointed one of their current members to also serve as a rep link to the related super-circle. The lead link is already shown, and may be the “manager” in the traditional organizational chart view.

Rep links may be particularly beneficial to upper management. They provide rapid feedback from the perspective of someone who really knows what's going on at the “street” level of the organization, and often provide key insights that upper management and executive officers often don't have.

In a traditional company it's wise for a CEO to consider the impact of his or her proposals on lower levels in the organization, and if something is missed it is a near certainty that the CEO will be blamed for the oversight. With the invention method in place, upper management can simply focus on their particular levels of scale and trust the rep links to catch any issues and help craft proposals that are workable for all parts of the organization.

Moreover, when a rep link misses something, those employees in their respective sub-circles don't look askance or toss recriminations at upper management; instead, they look to their rep link as a conduit for improving the situation. It is an accountability of the rep link to ensure the needs of the sub-circle are met, rather than upper management's. As each sub-circle has the intrinsic authority to elect their respective rep link, if the rep link is not fulfilling this accountability the sub-circle may elect a new rep link who can. Rep links thus help free executive officers and upper management from dealing with organizational politics, leaving them more time and energy to focus on moving the organization forward.

C. Requisite Organization

Once an organization adopting various aspects of the invention has all the basics in place, a new series of questions about the embodiment organizational structure often arise. For example, how does the organization determine what specific circles should be defined, and how many levels these should be organized into? How does the organization determine what specific accountabilities to define, which role should own which accountabilities, and which circle should own which role? Finally, do any of these questions really matter? The answer is a strong yes, it definitely does. Indeed, such questions are an issue in any organization, with or without the various aspects of the present invention, but with the present invention in place the ability to both find and harness an effective structure seems to increase significantly.

It is believed that at any given point in time, an organization has a naturally ideal or “requisite” circle structure, which “wants” to emerge. And within that circle structure there seem to be requisite roles and accountabilities. In other words, the organization is a natural organizational structure consistent with the present invention that has emerged over time and will evolve with time. This requisite structure is not an arbitrary choice. Finding it is detective work, not creative work—the answer already exists, it just needs to be uncovered. This discovery process feels a lot less like explicit design and a lot more like listening and attuning with what reality is already trying to tell you—what naturally wants to emerge.

The benefits of doing this listening are significant. The closer explicit structures mirror natural structures, the more effective and trust-inducing the organization becomes. As an organization aligns with the requisite structure, the organization feels increasingly “natural,” and self-organization becomes easier. Circles feel more cohesive; they have healthier autonomy and clearer identity, and more clear-cut interplay with other circles. Each circle more easily performs its own leading, doing, and measuring, with its super-circle able to more comfortably focus on specific inputs and outputs rather than the details of the processing going on within. Roles and accountabilities become more clear and explicit, and it becomes easier to match accountability to control. Aligning with requisite structure dramatically eases and enhances everything the present invention already aims for.

Shifting a traditional business to an initial embodiment structural arrangement is relatively easy. Most businesses have a hierarchical arrangement that can be easily converted into a nested circle structure. Typically, what is done is to take the current organizational chart for the business and draw circles around every manager and those immediate employees of that manager, as shown in FIG. 3. This process is continued up the organizational chart, with the net effect of having a series of interlocking and overlapping circles as the starting hierarchy for the organization. Then, elections, which are discussed later, are run to create the rep links, the managers forming the lead links. In certain embodiments, elections are begun from the lowest, or inner-most circles, and then continue upwards. In this manner, each elected official has the ability to participate in the corresponding higher-level election. Because of this, it is possible for a lower-level rep link to be recursively elected up to a circle that is higher than the immediate super-circle of the rep link's home circle. Once an initial structure is formed it may subsequently evolve, as provided by the invention method, to find its “true” or “natural” form, if necessary.

Alternatively, a large organization may choose to implement the invention method in only a sub-section of its total structure, typically in a lower-level department or team, which may be used as a trial process before transitioning the entire organization over to the present invention method. As a result, the invention method may be implemented incrementally across an organization, allowing that organization to learn as it goes.

### II. Organizational Control

Among the most fundamental paradigm shifts of the various embodiment aspects is the approach to maintaining organizational control. This shift may permeate the entirety of the instant method embodiments, and understanding other practices often takes considering them within this context.

A. Dynamic Steering

Most modern decision-making and management is based on attempting to figure out the best path to take, in advance, to reach a given goal (predict), and then planning and managing to follow that path (control). This is akin to riding a bicycle by pointing at a far off destination, holding the handlebars rigid, and then pedaling with gusto. Odds are the target will not be reached, even if the bicycle does manage to stay upright for the entire trip.

In contrast, when watching someone actually riding a bicycle, it is clear that there is a slight but constant weaving. The rider is continually getting feedback by taking in new information about his present state and environment, and constantly making minor corrections in many dimensions (heading, speed, balance, etc.). This weaving is the result of the rider maintaining a dynamic equilibrium while moving towards his goal; that is, using rapid feedback to stay within the constraints of the many aspects of his system. Instead of wasting a lot of time and energy predicting the exact “right” path up-front, he instead holds his purpose in mind, stays present in the moment, and finds the most natural path to his goal as he goes.

For organizations, preferring continual incremental adaptation with real data rather than detailed up-front analysis and prediction provides many benefits. These can include significant efficiency gains, higher quality, more agility, increased ability to capitalize on ideas and changing market conditions, and, perhaps most ironically, far more control. Moreover, the dynamic approach achieves these business benefits while meeting human and social needs at a level far beyond the traditional approach.

It is important to note that transcending the predict-and-control model is not at all the same as just “not predicting,” no more than riding a bicycle is a process of “not steering.” It is about attuning to an appropriate purpose and being fully present in the here and now, and steering continuously in a state of flow with whatever is arising. Doing this across an organization requires an enabling structure provided by the various embodiment structures and a disciplined process of continually taking in feedback and adapting across multiple people and multiple semi-autonomous teams. Rapid feedback provides for effective dynamic steering. Feedback allows plans to be imperfect at the start of a journey and quite good by the end. Rapid feedback also provides the data needed to make adjustments to the planned route based on the actual territory encountered, rather than trudging forward blind with nothing but a predictive “map” of what the territory is thought to look like.

1. Rules of Dynamic Steering

Various embodiments of the organizational control aspect of the present invention may utilize three rules for effective dynamic steering: 1) Any issue can be revisited at any time, as new information arises—steer continually, whenever needed; 2) The goal at any given moment is to find a workable decision, not necessarily the “best” decision—make small workable decisions rapidly, and let the best decision emerge over time; 3) Present tensions are all that matter—avoid acting on predictive tensions and delay decisions until the last responsible moment.

Preferred embodiments provide that under dynamic steering, any issue can be revisited at any time. Dynamic steering often requires the making of quick decisions based upon the goal of the circle and the facts at hand. Knowing that an issue can be revisited later as new information arises helps to avoid getting bogged down by predictive fears or trying to figure everything out up front. This also ties in with rule #3, in which only present tensions are considered, and prevents wasted time and energy speculating about what “might” happen, rather than adapting rapidly as soon as reality provides solid evidence of what actually is happening. This also leads to a lot less agonizing over the “perfect” decision, and makes it psychologically easier to just try something and see what happens, knowing that the course can be altered at any time.

Preferred embodiments also employ the above rule #2. The goal at any given moment is not to find the best possible decision, but merely to find a workable one. The best decision is typically not the one predicted in advance, but instead is the one that emerges into reality over time. Dynamic steering helps an organization quickly start with something workable, then reach superior decisions by listening to reality and adapting constantly as new information arises. Avoiding the trap of trying to find the “best” decision up-front frees a circle to swiftly move from planning a decision to testing it in reality and integrating the resulting feedback.

The concept of failure may also play an important part in dynamic steering. A “failure” at one level of scale is just new information and an opportunity to learn and succeed in the bigger picture. Dynamic steering, in combination with the rapid feedback loops provided by the present invention, allow the information gleaned from a failure to be used in the crafting of a new solution. In effect, the organization can place an emphasis on getting started, failing fast, and learning fast from that failure. Failing fast at relatively small levels of scale may allow an organization to more swiftly succeed in the bigger picture.

Practiced together, the rules of dynamic steering thus remove a lot of the fear from decision making, and that is key to boosting organizational agility while spending a lot less time in decision-making processes. It is believed that dynamic steering may result in less time in decision-making, rather than more. Predicting the future is scary. When a business is stuck with the results of a prediction, as it often is in modern organizational life, then that fear is also useful as it provides the strong impetus to predicting the right path to take. However, it is equally responsible for introducing rigidity; if a path appears to be working, then there is a strong motivation to stay the course, despite the presence of potential opportunities that may arise.

In contrast, holding an aim in mind while living fully and continually in the present is not scary, and to the extent that an organization can do that, fear becomes no longer useful. Dynamic steering makes it safe to just try something, and revisit issues whenever any potential fears begin to actually manifest. Where many individual transformative practices focus on helping individuals operate from a space beyond fear, the present invention shifts the fundamental context to one that reduces the degree to which fear arises in the first place. This facilitates much more useful and fulfilling emotional reactions towards both the process and results of decision-making, and allows an organization to seize opportunities in its environment that might otherwise go missed.

The other practices of the present invention come into play here as well. The circle organization may prove highly effective for dynamic steering, as each circle owns and controls its own decisions and policies, performs its own work, and then adapts its decisions and policies based on real feedback. Double linking, with elected representatives, enables adaptation beyond the level of a single circle and in a manner integrated with other circles. And circle meetings, discussed later, provide regular, integrative forums that allow individuals to air and address their tensions.

2. Integrating Predict & Control

It may be noted that there are times when predictive steering makes sense. Integrating future possibilities into present decision-making makes sense if both the probability of a costly possibility arising is uncomfortably high, and if the organization recognizes that it cannot safely adapt later once it has more information to work with. That is, if the organization will be locked into a fixed path without the opportunity to steer, then this may be recognized as a big decision for which predictive steering may be required. Real estate transactions tend to fall into this category. If an organization must sign an expensive ten year lease on office space and won't be able to change or renegotiate the lease later, then up-front prediction may be called for.

However, what would otherwise be a situation requiring predictive decision-making may often be transformable into one that allows dynamic steering simply by creating a way to add feedback and steering points along the path. For example, processes and contracts with clients and vendors may be intentionally crafted to allow and harness dynamic steering. One aspect of this crafting is to break down otherwise large commitments so that a small decision can be made now and the next small decision deferred until the last responsible moment. The organization should also ensure that it is effectively measuring what happens to get the data needed to dynamically steer before the next commitment. Of course this can be quite a challenge and it is not always practical; when the situation absolutely calls for it, sometimes the dynamic thing to do is to use a predict-and-control model. In this sense dynamic steering adds to and yet also fully includes predictive steering methods; dynamic steering is a broader, more encompassing paradigm.

B. Decisions by Integrative Emergence

Within an organization, different individuals may be attuned to different fields of information, which may lead to different views and conclusions about the same problem or goal. This may lead to the perception that one individual is wrong and another is right. Yet, when considered more closely, it is often found that there is at least some value or core truth in anything anyone perceives. As integral philosopher Ken Wilber has said, “No one is smart enough to be 100% wrong.”

With the speed and demands of modern organizational life, it's not surprising that businesses often fail to integrate the key perspectives of others. Yet, a more complete picture of the present reality facing an organization would be found if a rapid an effective method of bringing together and integrating these diverse points of view existed. A better picture allows for more powerful actions that take into account more needs and more constraints of the situations an organization find itself in.

The present invention provides a tool for exactly this kind of rapid integration of key perspectives, which may be termed “Decisions by Integrative Emergence.” Various embodiments recognize that each individual in an organization may have access to information or views that could be important, and provides the structure and procedures to incorporate these views. This rapid decision-making process systematically integrates the core truth or value in each perspective put forth, while staying grounded in the present-tense focus provided by dynamic steering. As each key perspective is integrated, a workable decision tends to emerge. A circle will know when it has achieved this integrated state when each member of the circle making the decision sees no “objection” to proceeding with the proposed decision, at least for now. An “objection” may be defined as a tangible, objectively reasonable, present-tense explanation for why the proposed decision is not workable right now—why it is outside the limits of tolerance of some aspect of the organization. A concern about a future event or possibility does not, in various embodiments, provide the basis for a valid objection. Thus, objections belong to the circle; they are not the personal objections of one or more individuals. An individual need be neither “for” nor “against” a proposal; a proposal is simply adopted when there is no objection, and the process and results are therefore highly impersonal. As long as objections have surfaced, the process continues to refine the proposed decision by integrating the core truth in each perspective, but no one can “block” a decision based purely on dislike.

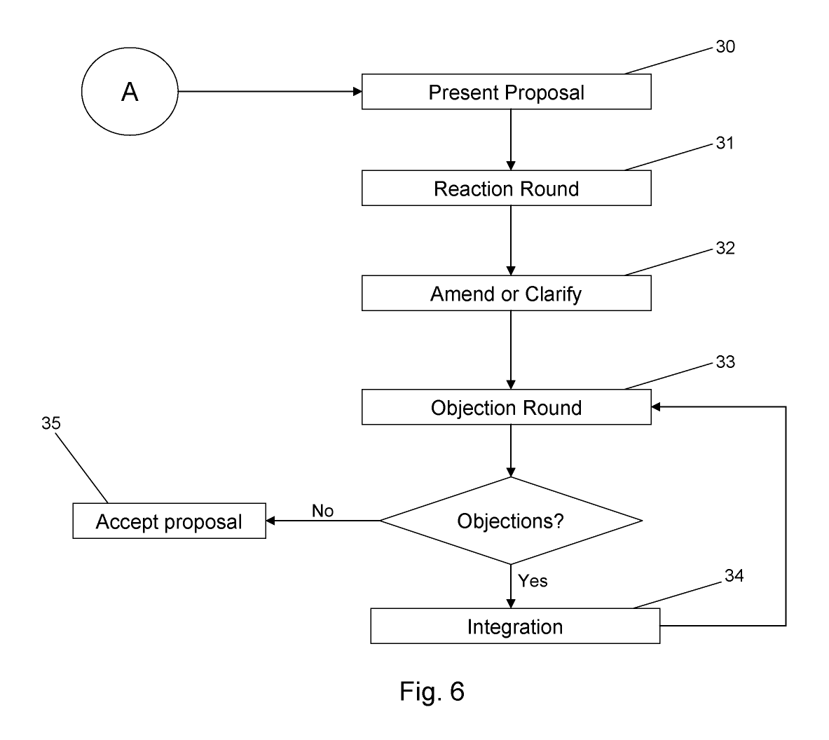

By way of example, a circle may employ as a Decisions by Integrative Emergence process the steps shown in FIG. 6. Although several facilitation formats may be available for Integrative Emergence, the following steps, as shown in FIG. 6, may be particularly suitable when a circle member has both a tension to resolve and a specific proposal to offer as a starting point for integration. Consistent with the rules presented above for dynamic steering, the following format may be employed immediately when a tangible, present tension is made known. This process is typically used within Governance Meetings, discussed later, which may be regularly scheduled (perhaps once per month). Alternatively, the meeting may be call ad hoc by a member of the circle; the proposer, for example, may call the meeting.

Present Proposal 30: The proposer states the tension to be resolved and a possible proposal for addressing it. Clarifying questions are allowed solely for the purpose of understanding what is being proposed. Discussion and reactions are cut off immediately by the facilitator, especially reactions veiled in question format (e.g. “Don't you think that would cause trouble?”).

Reaction Round 31: The facilitator asks each person in turn to provide a quick gut reaction to the proposal (e.g. “Sounds great,” “I'm really concerned about X,” etc.). Discussion or cross-talk of any sort may be ruthlessly cut off by the facilitator—this is sacred space for each person to notice, share, and detach from their reactions, without needing to worry about the potential effect of sharing them.

Amend or Clarify 32: The proposer has a chance to clarify any aspects of the proposal they feel may need clarifying after listening to the reactions, or to amend the proposal in very minor ways based on the reactions (only trivial amendments should be attempted at this stage, even if there were clear shortcomings pointed out). Discussion is cut off by the facilitator.

Objection Round 33: The facilitator asks each person in turn if they see any objections to the proposal as stated. Objections are briefly stated without discussion or questions; the facilitator lists all objections on the board, and cuts off discussion of any kind at this stage. If the objection round completes with no objections surfaced, the decision is made and the process ends at step 35.

Integration 34: If objections surface, once the objection round completes, the group enters open dialog to integrate the core truth in each into an amended proposal. As soon as an amended proposal surfaces which might work, the facilitator cuts off dialog, states the amended proposal, and goes back to an objection round.

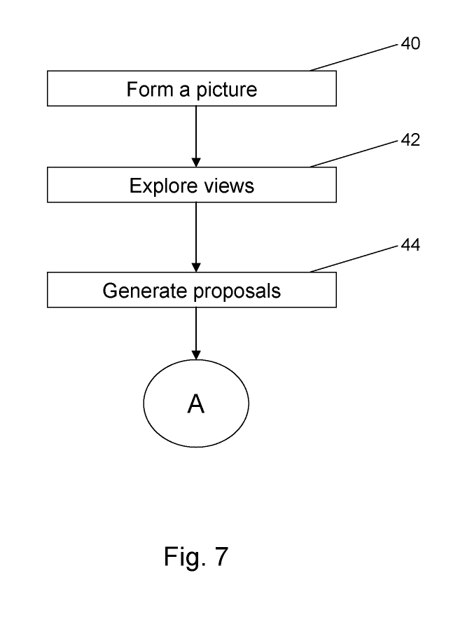

By way of further example, a circle may employ as a Decisions by Integrative Emergence process the steps shown in FIG. 7. The following steps presented in FIG. 7 may be particularly suitable when a circle member has identified a tension to resolve but has no specific proposal to offer. The following format may be employed immediately when the proposer, for example, learns of the tension.

Form a picture 40: The facilitator, proposer or both clarify the core topic to be address.

Explore views 42: The facilitator asks for tensions and information from each circle member about the topic and charts them, using, for example, a mind map. The facilitator then quickly ensures that the group has a clear picture of the tensions to address and no objections to proceeding.

Generate proposals 44: The facilitator starts a process to generate a proposal or a set of proposals that addresses one or more of the tensions on the mind map. The facilitator may do this using any appropriate or suitable technique. Common methods include dialog and brainstorming; or directly asking each person in turn, without discussion, what he or she would propose and listing everything stated on a board. Once there are one or more concrete proposals, the facilitator may then use the format indicated in FIG. 6.

1. Beyond Consensus

Using Decisions by Integrative Emergence is not at all the same thing as seeking consensus. The two are, in fact, barely comparable. Consensus-based processes typically ask whether people are “for” or “against” a proposal, or maybe whether anyone “blocks” it. Decisions by Integrative Emergence on the other hand doesn't focus on personal support at all, one way or the other; it is totally orthogonal to that. An “objection” isn't a statement that someone won't support a decision, nor is “no objection” a statement that someone is “for” it. There are no votes, per se. Instead, there are simply statements about whether or not someone sees something that is outside the limits of tolerance of any aspect of the system. Generally, it is up to the person filling a role to use their best reasonable judgment to assess the limits of tolerance that relate to that role; hence, limits of tolerance need not be explicitly published, though they may be used to determine if a legitimate objection exists.

This is a significant distinction. Asking someone if they are “for” or “against” something tends to push them into an egocentric or highly personal space. Decisions by Integrative Emergence asks them to speak from a more impersonal (or transpersonal) space about what is actually needed and workable for the collective goal. The process acknowledges and honors whatever emotions arise within an individual, and then helps that individual to move beyond these emotions; to make the emotions objects in the awareness of the individual but which but which do not own or control that individual. Once an individual is no longer controlled by his or her emotions, these personal emotions may act as clues as to why a proposed decision may really be outside a key limit of tolerance for the system. Personal emotions become sources of valuable information, but not decision-making criteria in and of themselves.

This shifts the focus from the personalities and emotions to the issue itself and the goals of the organization. This achieves the values sought in a consensus-based approach without the associated baggage, by recognizing that the best way to get the best decision is to continually listen to and integrate present-tense perspectives raised by the individuals involved. No single individual's voice is crushed, and yet egos aren't allowed to dominate. The Decisions by Integrative Emergence process helps people meet and interact in a state beyond fear and ego; a group engaged in it has a palpably different feel to it, and usually generates far better results.

When employing a Decisions by Integrative Emergence process, it often feels like the people involved in the process aren't actually making the decisions per se. They are holding a space and listening to reality, and allowing the creative force of evolution itself to make the decisions—through them, rather than from them.

2. The Enemy of Good Enough

As discussed earlier, one threshold of decision-making in the present invention is merely the discovery of a “workable” decision. Organizational dysfunction occurs whenever any part of the organization lacks sufficient control to ensure its own effective operation (when it lacks “requisite control”). So a “workable” decision may be defined simply as one which maintains the ability to effectively control the organization. This then dodges entirely the tricky and wasteful business of finding agreement of the “better” or “best” decision amongst the participants. In various embodiments, a decision is not sought that fully takes into account all perspectives. Instead, a decision is sought that takes into account the minimally-sufficient perspectives required to ensure the organization maintains or restores requisite control.

There is no need for everyone present to understand all aspects of a decision or even why it makes sense. They just need to have confidence that the decision will not undermine any part of the organization's ability to function effectively—to control itself. There is rarely a need for anyone to be convinced of anything, since the goal is not to find the “best” decision.

Practically speaking, when multiple workable options exist the better decision is often the one that's made more quickly. Quicker decision-making means more decisions can be made, more approaches can be tried, and more can be learned about what really works and what really doesn't. Requiring only a workable decision can be seen as “lowering the bar” on decision-making, but more accurately, it is “raising the bar” on slowing or stonewalling the decision-making process. An organization can continually improve quality by allowing itself to rapidly learn from experience.

Various embodiments may expressly push against attempts to fully integrate all perspectives at any given moment in time, and yet over time these embodiment methods may end up integrating more than any other conventional process. It isn't always possible to step back and integrate all perspectives; no matter how much an organization may integrate, there is always something more still to integrate, and more reality still emerging. Integrating perspectives is a process, an evolutionary one that unfolds through time, not something that is “done” at any one point. So, what an organization can do is be integrating; it can become an agent for the natural evolutionary impulse at the heart of reality, by riding the emerging moment here and now and integrating what actually arises into that present moment. Various method embodiments seek to integrate what needs integrating as it needs integrating—no more, no less, no sooner, and no later. The more an organization can find the discipline and skill required to do this, the more value that organization can integrate into its reality.

3. A Whole-System Shift

Various embodiments provide a whole-system change from what is typically expected in human organization and culture, and it can be very difficult to understand by looking at any one aspect alone. Each aspect reinforces and is reinforced by the others. The Decisions by Integrative Emergence process may be greatly facilitated by dynamic steering. Similarly, in certain circumstances it may be difficult to dynamically steer without the clear view of reality that comes from rapidly integrating key data. And it may be hard to rapidly integrate all necessary perspectives if an organization falls out of present-moment awareness and tries to integrate every fear of what “might” happen in the future. But when an organization dynamically steers its decisions arrived at by Integrative Emergence, each aspect may reinforce the other. The collective effect is greater still when both aspects, Decisions by Integrative Emergence and dynamic steering, are supported by yet other aspects of the invention method. Hence, a whole-system shift may be provided by various preferred embodiments.

4. Integrating Autocracy

Despite its power, most decisions in an organization employing an embodiment of the present invention are actually not made directly via the Decisions by Integrative Emergence process. Most of the decisions faced day-to-day are relatively simple and most effectively made by one person autocratically. Yet, as a rule in various embodiments, the governance decision to give autocratic control over certain operational decisions is always done via Decisions by Integrative Emergence. Indeed, in many embodiments, the default state is that all decision must be performed through a Decisions by Integrative Emergence process, unless another decision-making process is provided for. That is, defining and assigning roles and accountabilities and the type of control that goes with them is done through Decisions by Integrative Emergence. In fact, in various embodiments by default any accountability assignment also grants autocratic control with regard to that specific issue, unless another accountability exists which limits this control, such as an accountability to integrate other perspectives before making a decision. In this way Decisions by Integrative Emergence wraps and integrates other decision making styles, though the authority delegation itself can always be revisited via circle meetings, discussed below, as new information arises.

For example, an organization would not want an office manager calling a meeting every time he or she wanted to buy more pencils, so instead the Decisions by Integrative Emergence process is used to create a role with accountability and autocratic control to make decisions relating to keeping the office up and running operationally, within certain purchasing limits. Should this authority ever prove too broad or the limits too restrictive, the policy would again be revisited via the Decisions by Integrative Emergence process, and the circle would adapt incrementally. By way of dynamic steering, once a problem is found with the authority, the decision granting or limiting such authority may be immediately revisited, for example by the office manger or by any other individual in the circle who has identified a tension.

C. Individual Action

No matter how detailed and refined the roles and accountabilities may be, there will be cases where actions are needed which are outside of the role definitions, and thus outside of the official authority of the individual accountable for the role. In fact, in the initial stages of practicing an embodiment method, it is likely that most of what is done will fall outside of defined accountabilities, since the various embodiments typically encourage the evolution of roles over time instead of trying to predict what those roles need to be. Sometimes the action that believed needed is not just outside of defined accountabilities, but actually against them, such that taking the action would require neglecting or violating an accountability outright.

Rather than demanding a strict adherence to the roles and accountabilities regardless of the current situation, certain preferred embodiment instead encourage action along the line of that which humans usually do: Consider the information available, including is understood of the existing accountabilities or lack thereof, and then use the best judgment available to make a decision on what action to take. This may be termed “Individual Action.”

Individual Action tells an individual of the organization to do exactly what is usually hoped people do anyway: Consider the information available, use best judgment from the individual's highest self, and take whatever action believed to be best for the circle's goals. When that action falls outside or even against existing accountabilities, the individual should additionally be prepared to go the way to “restore the balance” from any harm or injustice caused, via a restorative justice system rather than a punitive one. Finally, the individual is expected to take the perceived need for such action to a governance meeting, so that the circle can learn from the case study by evolving roles and accountabilities to transcend the need for it next time. In this way, individual action drives organizational evolution.

For example, imagine that an employee in sales, who normally is not accountable for purchases of any kind, comes in on a holiday or weekend and learns, quite by accident, that a critical piece of computer hardware is missing that will be required on the next business day. This employee may know that there is another filling the role of a Purchasing Officer, who is accountable for all purchases of this nature. Indeed, there may be a requirement that all purchases go through the Purchasing Officer. After dutifully trying to contact the Purchasing Officer and failing, the employee is left with a decision: should he ignore the need and hence let a critical piece of infrastructure lapse, or should he take Individual Action and purchase the piece of equipment? Various preferred embodiments assert that the employee should assert the prerogative of Individual Action, with the caveat of accepting responsibility to the extent of performing reasonable ameliorative actions needed to address any resulting problems or issues that subsequently arise, and also raising the source of this tension in a subsequent governance meeting where the tension may be resolved, such as by creating a new, explicit accountability or role, or augmenting already-present roles or accountabilities. Hence, the employee may later learn that all purchases go through the Purchasing Office to avoid excessive paperwork that would otherwise result. Rather than having the Purchasing Officer handle the extra paperwork, as an ameliorative action the employee may volunteer to do it instead. In a subsequent governance meeting, the circle may then come up with proposals to handle such emergency situations, and the organization as a whole has “learned” from the event.

Recognizing individual action as an expected practice within the organization has a profound effect on organizational culture. It helps avoid getting stuck in all the blame, negativity, and “should have's” that otherwise get thrown around in the typical modern organization. These are all reasonable emotions that get confused for facts about reality—they become resistance to what has already happened and can't be changed. Expecting individual action helps shift the individuals within and organization from blame and fear of blame to living in the present and courageously facing the future together.

D. Circle and Role Autonomy in Governance

As touched upon earlier, apart from the connections they have through lead and representative links, circles are, in various preferred embodiments, autonomous units. By way of governance meetings, discussed below, a circle may establish and assign accountabilities and roles; may adjust or delete current accountabilities, roles or both, may assign members of the circle to fill roles, and may set operational procedures in place, such as the frequency of meetings and the like. By extension, a circle is thus free to break itself up into as many sub-circles as may be deemed desirable, and appoint the lead links for those newly created sub-circles. Once created, the sub-circles may hold elections to appoint their respective representative links, and thereafter may operate as semi-autonomous entities in their own right.

However, what should be further appreciated is that roles themselves may also, in various embodiments, break themselves n to a plurality of sub-roles. As previously noted, assignment of accountabilities to a role implicitly provides that role all executive power reasonably needed to fulfill the accountabilities. Hence, unless otherwise prevented from doing so by another accountability, a role may autocratically “decide” to partition itself into various sub-roles, and then seek to acquire the resources to assign individuals to fill each of those sub-roles. This is, in fact, analogous to creating a sub-circle, where the new sub-roles are now roles owned by the new sub-circle. This allows the super-circle to look at the role as a single unified role, while in actuality the sub-circle breaks the role down into more manageable parts (via creating sub-roles). For example, from the perspective of a circle wrapping an executive team, there might be a single Product Development role, with accountability for creating all of the organization's products; while this looks like a single role from the perspective of the executive team's circle, it is really an entire department, broken down in a sub-circle into multiple roles such as project manager, programmer, analyst, etc. The lead link in this circle may be the original individual who initially filled the role; the members of the new sub-circle may be those individuals appointed to fulfill the sub-roles. The members of the sub-circle may then elect a representative link to complete the double linking of the sub-circle with the super-circle. When a role decides to partition itself into two or more sub-roles, the role may “break down” each of its accountabilities into new sub-accountabilities, which, when taken all together, fulfill one or more of the original accountabilities of that role. These sub-accountabilities may then be assigned to the sub-roles. For example, a higher-level Product Development role may be accountable for delivering all software projects. That accountability may not be handed directly down to a sub-role, but rather broken down into many accountabilities for new sub-roles, such as an accountability on a Project Manager role for organizing work to meet target schedules, among many others, all of which roll up to the original, higher-level accountability.

### III. Core Practices

A. Governance Meetings

In various preferred embodiments, members of a circle meet regularly to establish and evolve circle governance, which has been touched upon above. These members may include the lead link, which is appointed from a higher-level circle, any “home” members of the circle, lead links of that circle to lower-level circles, and rep links from those lower-level circles, as indicated in FIG. 5. Governance meetings focus on uncovering the general roles needed to reach the goal of the circle and the specific accountabilities and control required of each, and then assigning these roles to circle members. Attendance is open to all members of the circle, including the representative links elected to this circle from sub-circles. In certain embodiments, these meetings are typically held at least once per month for most circles, and sometimes more frequently. Different circles may have different scheduling arrangements for governance meetings.

In preferred embodiments, the focus of a governance meeting is governance, not operations. Governance meetings concern evolving the pattern and structure of the organization—defining how the individuals will work together—and are not about conducting specific business or making decisions about specific issues. That's not to say all talk of operational issues is avoided. In the spirit of dynamic steering, governance proposals are typically inspired by specific operational needs or events. Whenever something didn't go as well as may have been expected or liked, there are often additional requisite roles or accountabilities waiting to be uncovered in a governance meeting. Likewise, whenever it isn't clear who makes which specific decisions and how, there is likely a helpful clarification of roles and accountabilities ready to hatch, since control typically goes hand-in-hand with accountability. Note, however, that such decisions tend to decide who will later decide an operational issue, which is governance, rather than what operational issues are actually decided. For example, a governance meeting may be called to determine who will decide where the next operational meeting will be held, a question of governance; this same governance meeting would not, however, actually decide where the next operational meeting will be held, which is a specific operational question.

In preferred embodiments, the key to effective governance meetings is to continually pull the focus back to roles and accountabilities. Without a strong focus and a clear space held for governance, it's easy for an organization to get so caught up in the day-to-day operations that governance just doesn't happen, and regular governance meetings can play an important part in the effective practice of organizational structuring and control.

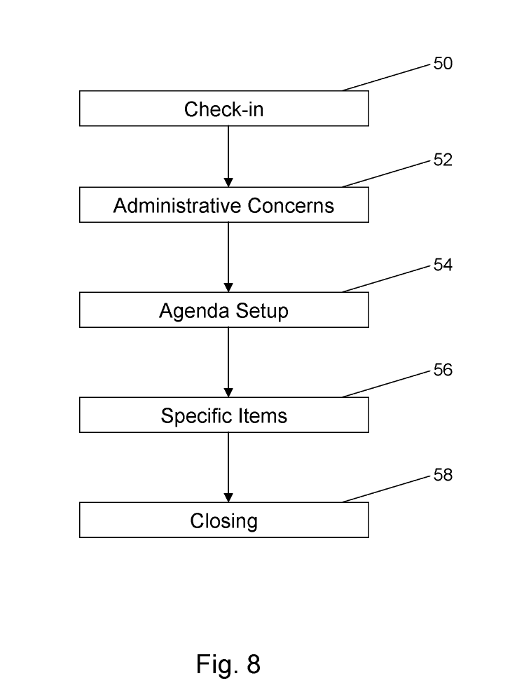

By way of example, steps for an embodiment governance meeting are presented in FIG. 8.

Check-in 50: The check-in is a brief go-around, where each person gives a short account of their current mindset and emotional state, to provide emotional context for others in the meeting and to help the speaker let go of any held tensions. The facilitator crushes discussion or reactions to others' check-ins. Example: “I'm a little stressed out from the project I'm working on today, but I've been looking forward to this meeting.”

Administrative Concerns 52: The facilitator quickly checks for objections to the last meeting's minutes, and explicitly highlights the time available for this meeting.

Agenda Setup 54: The facilitator solicits agenda items for the meeting on the fly. In certain preferred embodiments, agenda items are never carried over from prior meetings. Participants state agenda items briefly, as just a title, and the facilitator charts them on the board. Once all agenda items are listed, the facilitator proposes an order to tackle them in and quickly integrates any objections to the order.

Specific Items 56: The group proceeds through each agenda item until the meeting time elapses or until all items have been resolved. Each agenda item uses one of the Decisions by Integrative Emergence processes, such as those presented in FIGS. 6 and 7, or others. The secretary captures all decisions, preferably only the final decisions, in the meeting minutes, as well as in the overall compiled record of the circle's roles and accountabilities.

Closing 58: The closing is a brief go-around, where each person reflects and comments on the effectiveness of the meeting, providing feedback for the facilitator and others about the meeting process itself. The facilitator crushes discussion or reactions to others' closing comments. Example: “We ended up out-of-process in discussion several times, and it'd be useful for the facilitator to cut that off sooner next time.”

B. Integrative Elections

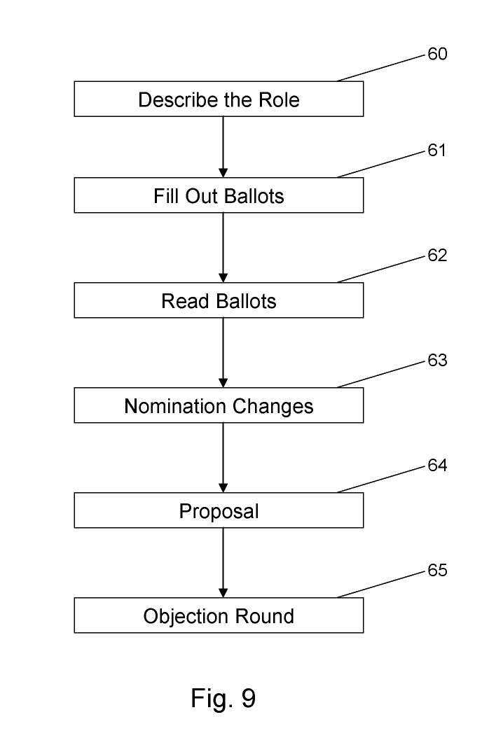

In preferred embodiments, there are several key roles that should be filled in each circle: a representative link to the immediate super-circle, a facilitator to run circle meetings and ensure the group sticks to the embodiment process, and a secretary to record decisions and maintain an overall compiled list of all the roles and accountabilities of the circle. Circle members are elected to each of these key roles by way of a method integrative election process, which seeks to tap the collective intelligence of the group to arrive at a best-fit for the role. In addition, the circle may choose to use this process for other roles as well; the integrative election method may be helpful whenever a clear best-fit for a role isn't immediately obvious. The steps of an embodiment integrative election method are presented in FIG. 9, and may include the following:

Describe the Role 60: The facilitator announces the role the election is for, and the accountabilities of that role.

Fill Out Ballots 61: Each member fills out a ballot, without any up-front discussion or comment whatsoever. Members may include the “home” members of the circle, as well as the lead and rep links. The ballot may use the form of “(Nominator's Name) nominates (Nominee's Name).” Everyone must nominate exactly one person. No one may abstain or nominate more than one person. The facilitator collects all of the ballots.

Read Ballots 62: The facilitator reads aloud each ballot and asks the nominator to state why he or she nominated the person shown on their ballot. Each person gives a brief statement as to why the person they nominated may be the best fit for the role.

Nomination Changes 63: The facilitator asks each person in turn if he or she would like to change his or her nomination, based on new information that surfaced during the previous round. Changed nominations are noted, and a total count is made.

Proposal 64: The facilitator proposes someone to fill the role, based on the information that surfaced during the process, which may include the total nomination counts. The facilitator may open the floor for dialog beforehand if necessary, although it's usually best to just pick someone to propose and move on without discussion.

Objection Round 65: This may be identical to the objection round 33 for the general Decisions by Integrative Emergence process discussed in reference to FIG. 6, however the nominee in question is asked last. If objections surface, the facilitator may either enter dialog to integrate them, or simply propose a different nominee for the role and repeat the objection round.

C. Operational Meetings

As referenced above, the members of a circle meet regularly in operational meetings to facilitate the effective execution of day-to-day business, consistent with the concept of dynamic steering. Operational meetings deal with the specific business of the organization. They are a forum for exchanging relevant information and making specific decisions that require integration of multiple roles in the circle. All members of the circle, including the rep links from any immediate sub-circles of that circle, are invited to operational meetings, although rep links may show up intermittently, or leave early when the topics aren't relevant to their scope.

There may be different types of operational meetings, with different rhythms, or heartbeats, ranging from quick daily meetings to annual offsite review sessions. The breadth of scope of each meeting typically is directly correlated with how frequently the meeting is held. The following presents brief descriptions of various embodiment operational meeting types.

1. Daily Stand-Up Meetings

Daily stand-up meetings are typically from 5 to 10 minutes in length, usually near the start of each work day. They may serve as a quick integration and coordination point for the day, and may focus on what each participant did yesterday, what they plan to do today, and what integration points arise as a result. The daily nature of these meetings may mean that they are not always practical, but when they are, they can be surprisingly useful time savers and efficiency boosters.

2. Tactical Meetings

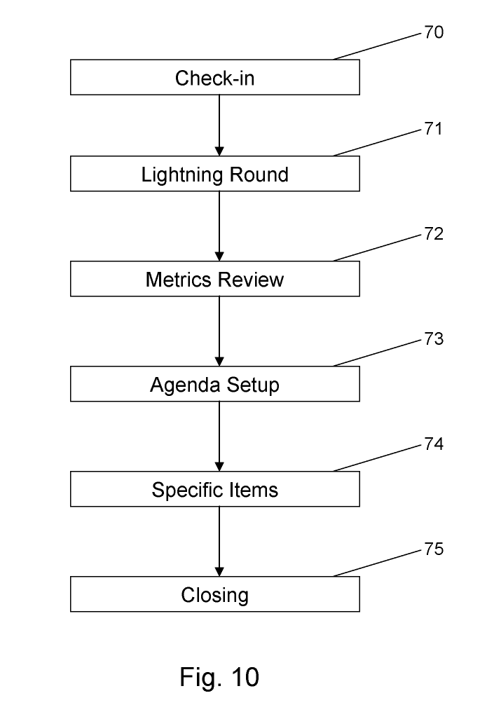

Tactical meetings are typically held once per week, although the requisite frequency may vary from organization to organization and circle to circle. These meetings may be used to collect up-to-date metrics relevant to the circle, such as the data required for effective dynamic steering, and for integrating around specific tactical issues the circle is presently facing. The output of the tactical meeting may be a list of action items, which the secretary may capture and distribute to circle members. FIG. 10 shows steps of an embodiment tactical meeting, which may include:

Check-in 70: This may be identical to the governance meeting check-in round 50 discussed with reference to FIG. 8.

Lightning Round 71: One by one, each participant states what they plan to work on in the coming week, with no discussion. Each person may be given, for example, a maximum of sixty seconds for this, and the facilitator cuts off anyone who runs over time.

Metrics Review 72: Each circle member with accountability for providing a metric presents that metric. Clarifying questions and minor commenting are allowed, although the facilitator will curtail any significant discussion. If it becomes clear that significant additional discussion will be needed, an agenda item for such discussion may be added, thus keeping this phase 72 to just getting the data out.

Agenda Setup 73: This phase may be identical to the governance meeting agenda setup 54 as discussed with reference to FIG. 8. In preferred embodiments, the agenda for tactical meetings is always built on-the-fly, with no carry-over from prior meetings.

Specific Items 74: The group proceeds through each agenda item, with the goal of completing the entire agenda before time elapses. These are preferably swift-moving meetings. Typically, each item is a brief free-form discussion. Tactical meetings do not necessarily use the Decisions by Integrative Emergence process, unless someone has an explicit accountability to integrate perspectives around a specific issue before taking action.

Closing 75: This may be identical to the governance meeting closing round 58.

The process used for any given issue in a tactical meeting may be a function of the accountabilities that exist. For example, if an organization is deciding upon a change to the salary system (which is an operational issue that may go in a tactical meeting), and if the CEO role has accountability for integrating all objections to a proposed salary system change, then the Decisions by Integrative Emergence process may be used for that issue. However, most roles and accountabilities do not have this kind of limit. Unless specifically indicated, there typically is no accountability to integrate other perspectives or objections; autocratic control is instead granted, with the corollary of having no need to integrate. For example, an office manager may have accountability (and thus control) for supplying the office with basic office supplies. There is no explicit accountability to integrate the perspectives of others; the office manager has autocratic authority in this regard. Nevertheless, the office manager may still bring up the topic in a tactical meeting to ask other employees what office supplies they'd like to have, and then she can use her judgment on what to do from there. In this regard, then, there is no need to make a proposal and integrate objections, because the office manager has been given autocratic authority. This implicit grant of autocratic authority avoids what may otherwise amount to a large waste of time in formal processes when all the role-holder is looking for is a little bit of input. Tactical meetings may therefore rely upon the roles and accountabilities setup in governance, which define who decides what and how in the tactical meetings, as well as outside the tactical meetings in the day-to-day operations of the organization.

3. Strategic Meetings

Strategic meetings are typically held monthly, quarterly, annually, or combinations thereof, depending on the organization and the circle. Whatever the frequency, strategic meetings preferably focus on the broad “big” issues facing the circle. They are a time to step back and creatively analyze the big picture. The format of strategic meetings can vary, and unlike governance and tactical meetings, agenda items here are preferably decided in advance to give everyone time to reflect and research prior to the meeting. The number of agenda items is typically limited to just one or two, even for a full day strategic meeting; strategic meetings are about digging deep into the most important issues in front of the circle.

4. Special-Topic Meetings

Special-topic meetings are about addressing one specific topic or agenda item. They are probably the closest thing to what most of us associate with a “normal meeting” in a traditional organization. These meetings often arise when something comes up at a tactical meeting which is too big to fit in the tactical meeting, yet isn't appropriate to park for possible inclusion in the next strategic meeting. The format of a special topic meeting depends upon the nature of the topic—anything from free-form dialog to one of the longer Decisions by Integrative Emergence formats may work well.

D. Add-On Practices

1. Chalupas

Sometimes there are decisions that simply cannot be delegated to one individual filling a role, but do not require the integration of all the viewpoints of a full committee or circle. In these cases, a smaller committee—the smallest group of people who can represent all the relevant viewpoints—can be formed to handle this accountability.

Note that this is not simply a sub-circle of some larger circle (although it might be), but is often a re-sampling of the entire organization to find the smallest group of people who can represent the relevant viewpoints. These groups may be termed Collaboration Groups (or “Chalupas” for short). In general, Chalupas are relatively short-lived; they are formed to tackle one decision, or achieve one goal. Once their purpose has been accomplished they disappear. A common use for Chalupas is to take ownership of deciding some thorny but tractable issue; the redesign of an office layout, for example.

Some Chalupas can exist on an ongoing basis, however. An organization could have a “Billing Chalupa” which is responsible for deciding issues related to both the billing model and making sure that billing runs effectively. With representatives from Sales, Invoicing, Accounts Receivable and Collections as well as Operations, the Chalupa may cut across the entire circle structure of the organization. But by having only a small group of representatives, which are not necessarily the heads of the various departments, the Chalupa may be able to rapidly reach decisions affecting the whole organization with the knowledge that each part of the organization was adequately represented.

Chalupas may be formed implicitly by the accountabilities setup in governance meetings. For example, if a Sales role is created with accountability for integrating input from the Development role to determine pricing, and a Development role is created with accountability for assisting Sales to determine pricing, then the organization has implicitly created what might be named a “Pricing Chalupa.” This intersection of roles and accountabilities creates a group that needs to work together operationally, and individuals may be appointed to this group to account for the related accountabilities.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A method for running an organization comprising:
assigning each individual in the organization to at least one of a plurality of circles;
at least one circle utilizing dynamic steering in the performance of periodic governance meetings to perform at least the following tasks:
defining a plurality of accountabilities, each accountability being an activity performed in service of the organization;
defining a plurality of roles;
assigning to each role at least one of the accountabilities;
assigning to each individual in the circle at least one of the roles; wherein each individual filling a role is accountable to the organization for every accountability assigned to that role; and
utilizing a decision-making process to resolve identified tensions within the circle; and
at least one circle utilizing dynamic steering in the performance of periodic operational meetings to perform at least the following tasks:
exchanging information and making decisions requiring integration of multiple roles in the circle;
reviewing metrics relevant to the circle; and
resolving tactical issues related to the circle.

2. The method of claim 1 further comprising each individual in the organization utilizing individual action to:
utilize best judgment to identify a task to be performed that is not already accounted for by a current accountability, or which is contrary to a current accountability;
perform the task; and
raise in a subsequent governance meeting the task.

3. The method of claim 2 further comprising the individual performing the task further performing any reasonable restorative action in response to performing the task.

4. The method of claim 1 wherein at least one of the circles has a lead link role with a related accountability of aligning the circle's governance or activities with requirements established by another circle.

5. The method of claim 4 wherein the individual filling the lead link role attends the governance meetings of both circles.

6. The method of claim 1 wherein at least one of the circles has a representative link role with a related accountability of ensuring another circle provides a conducive environment for the circle.

7. The method of claim 6 wherein the individual filling the representative link role attends the governance meetings of both circles.

8. The method of claim 1 wherein the governance meetings for a first circle perform the following additional tasks:
partitioning the first circle into a plurality of sub-circles; and
assigning to each sub-circle a member of the first circle to serve as a lead link for that sub-circle.

9. The method of claim 8 wherein at least one sub-circle performs an election process to elect a representative link for that sub-circle who will serve as a member in the governance meetings of the first circle.

10. The method of claim 1 wherein the governance meetings perform the following additional tasks:
identifying a first role with corresponding accountabilities;
partitioning the first role into a plurality of second roles;
assigning at least one accountability to each second role; and
assigning an individual to fill each second role.

11. The method of claim 1 wherein assigning each individual a role provides that individual autocratic power to perform all tasks reasonably necessary to fulfill the accountabilities of the role.

12. The method of claim 11 wherein all tasks reasonably necessary to fulfill the accountabilities of the role include:
partitioning the role into a plurality of sub-roles;
for at least one of the sub-roles, assigning at least a portion of one of the accountabilities corresponding to the role to that sub-role; and
assigning an individual to fill each sub-role.

13. The method of claim 1 wherein the decision-making process to resolve identified tensions within the circle employs a Decisions by Integrative Emergence process.

14. A decision-making method for an organization comprising:
identifying at least one accountability that is an activity to be performed for the organization;
assigning the accountability to a first role;
assigning an individual to fill the first role;
providing the individual autocratic power to reasonably execute all accountabilities assigned to the first role;
identifying a tension within the organization; and
adding an accountability to, or modifying an existing accountability associated with, the first role to resolve the tension.

15. The method of claim 14 wherein the first role is an element of a circle comprising a plurality of roles, and wherein adding an accountability to, or modifying an existing accountability associated with, the first role to resolve the tension is performed in a governance meeting of the circle.

16. The method of claim 15 wherein the governance meeting utilizes a Decisions by Integrative Emergence process to add an accountability to, or modify an existing accountability associated with, the first role.

17. A decision-making method for an organization comprising:
a) presenting a tension to a group within the organization, the group comprising a plurality of roles, each role accountable for at least one accountability;
b) soliciting information about the tension from the group;
c) soliciting a proposed decision from the group to resolve the tension;
d) soliciting objections to the proposed decision from the group; wherein an objection is an objectively reasonable explanation for why the proposed decision is outside a limit of tolerance of the organization;
e) repeating steps b through d if an objection is present; and
f) accepting as a course of action for the organization a proposed decision that has no objections, wherein the course of action comprises changing an accountability associated with at least one role within the group.

18. The method of claim 17 wherein the first proposed decision without an objection is accepted as the course of action for the organization.

19. The method of claim 17 wherein the objection is a present-tense, objectively reasonable explanation for why the proposed decision is outside a limit of tolerance of the organization.
